(19) United States
(12) Patent Application Publication
(10) Pub. No.: US 2019/0167532 A1
(43) Pub. Date: Jun. 6, 2019

(54) FLAVORED PACIFIER

(71) Applicant: Jamie Freeman, Apo, AE (US)

(72) Inventor: Jamie Freeman, Apo, AE (US)

(21) Appl. No.: 15/831,934

(22) Filed: Dec. 5, 2017

(51) Int. Cl. A61J 17/00

(52) U.S. Cl. CPC A61J 17/001; A23G 3/50

(57) ABSTRACT

The present invention has two separate items the pacifier and the food compartment. The main purpose of the present invention is to expand the functionality of traditional pacifiers, specifically, to provide food flavors to the ply latex portion.

### BACKGROUND OF THE INVENTION

### Field of the Invention

The present invention is a pacifier. More specifically, the present invention is a flavored pacifier.

### Description of the Related Art

The present invention has two separate items the pacifier and the food compartment. The main purpose of the present invention is to expand the functionality of traditional pacifiers, specifically, to provide food flavors to the ply latex portion. Pacifiers are common accessories which individuals provide to infants for teething and comfort purposes. Current products on the market however, consist of latex or silicone sucking tips, which are flavorless and may leave an odd taste in a baby's mouth. The present invention introduces a baby binky which allows consumers to insert small foods into the device, eliminating the taste of synthetic compounds from their mouths and providing tasty flavors instead. The present invention is simple to use, individuals can open the food compartment of the sucker, insert a food item, such as mash potatoes, pureed baby food, yogurt, etc., seal the compartment, and place it inside the baby's mouth, enabling them to suck the food into their mouths and savor its flavor while using the pacifier. Once finished, one can open the food compartment of the present invention and easily wash out any remaining food, leaving the accessory clean for future use. The present invention can easily appeal to all consumers with infants, as it adds a novel alternative to the use of traditional binkies, making it possible to be readily available at diverse department stores and/or online retailers.

The flavored pacifier is the only product of its kind to present a feature created to avoid the occurrence of infants being exposed to a rubbery after taste as they suckle on the composition materials of pacifiers. The flavored pacifier is uniquely designed with a food compartment, allowing consumers to choose what flavor the binky will have, making the product adaptable to the varying palates a toddler may prefer.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a flavored pacifier, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

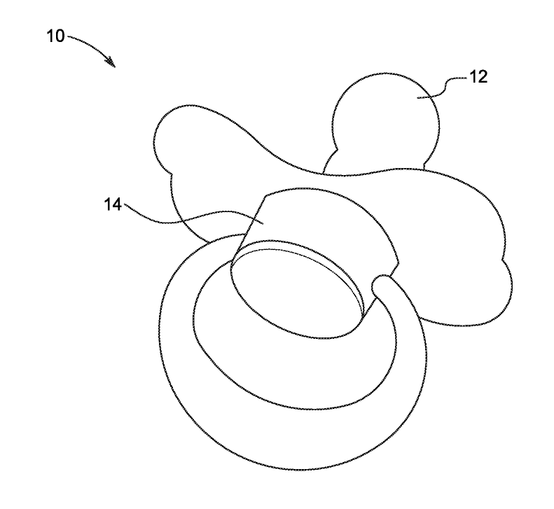

FIG. 1 illustrates a flavored pacifier 10, in accordance with one embodiment of the present invention.

The flavored pacifier 10 may include a pacifier 12 and a food compartment 14.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention

What is claimed is:

1. A pacifier, comprising:
a food compartment; and
a flavored pacifier connected to the food compartment;

2. The pacifier according to claim 1, wherein small foods are inserted into the food compartment.

3. A sucker comprising:
a food compartment of the sucker adapted to insert a food item a user can suck the food into the users mouth and savor the food items flavor while using the sucker.

4. The sucker according to claim 3, wherein the sucker can be easily washed out leaving clean for future use.
